(19) United States
(12) Patent Application Publication
(10) Pub. No.: US 2009/0220850 A1
(43) Pub. Date: Sep. 3, 2009

(54) Liquid-Cooled Battery and Method for Operating Such a Battery

(75) Inventors: Otmar Bitsche, Stuttgart (DE); Markus Bulling, Biberach (DE); Wolfgang Duerr, Westerstetten (DE); Wolfgang Schwienbacher, Dettingen (DE); Thomas Soczka-Guth, Schelklingen (DE); Lars Weinschenker, Royal Oak, MI (US)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/911,367

(22) PCT Filed: Apr. 3, 2006
(86) PCT No.: PCT/EP06/03007

§ 371 Date: Jun. 10, 2008

(30) Foreign Application Priority Data
Apr. 15, 2005 (DE) 10 2005 017 648.8

(51) Int. Cl. H01M 10/50; H01M 2/12

(52) U.S. Cl. 429/50; 429/71

(57) ABSTRACT

A liquid-cooled battery, in particular in the form of an energy store for an electrical drive in a motor vehicle is provided. The battery has a plurality of storage cells 2 and at least one volume 4 which makes thermally conductive contact with the storage cells 2 and through which a cooling medium can flow. Each of the storage cells 2 has a safety valve 12 which opens the storage cell when a predetermined media pressure in it is exceeded, and connects the volume of the storage cell to the surrounding area. The safety valve 12 is arranged in the storage cell 2 and the storage cell 2 is arranged with respect to the volume 4 through which the cooling medium can flow such that a connection is produced between the volume 4 through which the cooling medium can flow, and the interior of the storage cell 2 if the safety valve 2 is operated.

### CROSS REFERENCE TO RELATED APPLICATIONS

This application is a continuation of PCT International Application No. PCT/EP2006/003007, filed Apr. 3, 2006, which claims priority under 35 U.S.C. § 119 to German Patent Application No. 10 2005 017 648.8, filed Apr. 15, 2005, the entire disclosures of which are herein expressly incorporated by reference.

### BACKGROUND AND SUMMARY OF THE INVENTION

The invention relates to a liquid-cooled battery and to a method for operation of a liquid-cooled battery.

JP 2004 178 909 A discloses a battery in which the individual battery cells each have a safety valve. If the pressure in the respective battery cell becomes excessive, the valve opens so that the gases escaping from the respective storage cell are blown out to the surrounding area. This has the disadvantage that the hot and possibly explosive gases are passed to the area surrounding the battery, where they can possibly lead to damage, for example, a fire.

Furthermore, JP 10 241 739 A discloses a storage cell for a cooled battery, which likewise has a safety valve that opens above a specific temperature limit and has a cooling cartridge. The cooling cartridge itself once again also has a safety valve which is likewise opened, by means of the medium emerging from the safety valve of the storage cell, such that it can be activated thermally. This makes it possible to slightly cool down the emerging media. Owing to the comparatively small amount of cooling medium

Furthermore, EP 0 476 484 B1 discloses the storage cells of a battery being cooled only from at least one of their end faces.

The present invention provides a liquid-cooled battery, in particular as an energy store for an electrical drive in a motor vehicle, which allows good operating characteristics with a compact design which can be handled easily, and satisfies very stringent safety requirements.

According to the invention, this is achieved by a battery having a liquid-cooled battery, in particular in the form of an energy store for an electrical drive in a motor vehicle, having a plurality of storage cells and at least one volume which makes thermally conductive contact with the storage cells and through which a cooling medium can flow, with each of the storage cells having a safety valve which opens the storage cell when a predetermined media pressure in it is exceeded, and connects the volume of the storage cell to the surrounding area, characterized in that the safety valves (12) are arranged in the storage cells (2) such that, when one of the safety valves (2) is opened, a connection is produced between the volume (4) through which the cooling medium can flow and the interior of the storage cell (29) to the open safety valve (12).

The connection according to the invention between a storage cell and the entire volume through which the cooling medium can flow in the event of the safety valve being operated by an overpressure in the respective storage cell represents a considerable safety advantage. Any media escaping from the respective storage cell, typically gases, are distributed in the cooling volume where they are mixed with the cooling medium, and thus rendered safe. In this case, the opening of the safety valve is sufficient to ensure that the battery is in a safe state.

The safety valve, which will typically be in the form of a flap, which can be opened via weak points, in the housing of the storage cells, is therefore responsible as a single, very reliable component for producing a safe battery state in the event of damage. The safety that can be achieved in this way is undoubtedly considerably better than in the case of comparable devices in which a chain of a plurality of components, some of which are complex, must be operated before a safe state can be achieved.

The battery according to the invention therefore ensures a simple design which can be implemented in a compact form and ensures a very high safety level by very simple passive means. This represents a considerable advantage, particularly when used in motor vehicles.

In this case, the expression passive should be understood as indicating that the means react automatically, driven by the energy of the state, when the critical state occurs without any need for a sensor system with subsequent operation on the basis of a value which is detected passively or actively by sensors.

The present invention also provides a method for operation of a liquid-cooled battery, in particular in the form of an energy store for an electrical drive in a motor vehicle, which satisfies very stringent safety requirements.

According to the invention, this is achieved by a method for operation of a battery, in particular as an energy store for an electrical drive in a motor vehicle, having a plurality of storage cells and at least one volume which makes thermally conductive contact with the storage cells and through which a cooling medium flows, with a safety valve being opened above a predetermined pressure limit in the event of a pressure rise, based on a fault, in any of the memory cells, characterized in that, when the safety valve is opened, a connection is produced between the volume through which the cooling medium flows and the storage cell so that the overpressure can escape into the cooling liquid.

In the method according to the invention, a connection between a storage cell and the entire volume through which the cooling medium can flow is produced by a passive safety technique in the event of damage. The media escaping from the respective storage cell, typically gases, are thus distributed in the cooling volume where they are mixed with the cooling medium and are thus rendered safe.

### BRIEF DESCRIPTION OF THE DRAWING FIGURE

Further advantageous refinements of the battery and of the method for operation of it will also become evident from the claims and from the exemplary embodiments, which will be described in detail with reference to the drawing, in which:

FIG. 1 shows a three-dimensional schematic illustration of the battery;

FIG. 2 shows a plan view of a cooler for the battery;

FIG. 3 shows a longitudinal section through the cooler for the battery;

FIG. 4 shows a cross section through a part of the battery cooler with a storage cell;

FIG. 5 shows a schematic section illustration of a storage cell linked to the cooler; and

FIG. 6 shows the illustration as in FIG. 5, with the safety valve open.

### DETAILED DESCRIPTION

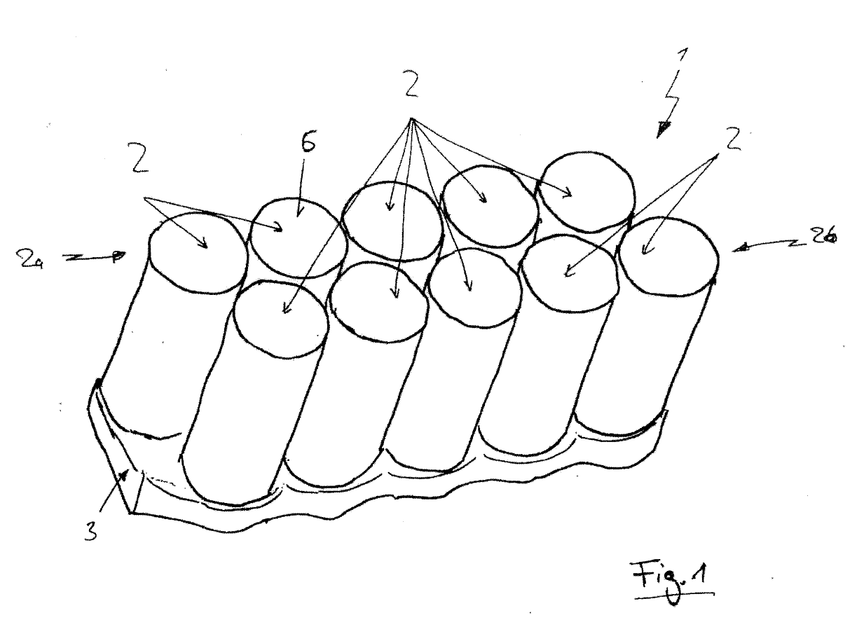

FIG. 1 schematically illustrates a battery 1. The battery 1 comprises a multiplicity of individual storage cells 2, which are arranged alongside one another in a plurality of rows 2a, 2b, in this case by way of example two rows 2a, 2b. The two rows 2a, 2b are in this case arranged offset with respect to one another, such that respectively adjacent rows 2a, 2b are shifted with respect to one another through half of the distance between the center lines of the individual storage cells 2 in one row. This allows the rows 2a, 2b to be packed very densely with respect to one another. Overall, this results in the battery 1 having a very compact design.

The battery is also cooled via a cooler 3 which has a volume 4 (although cannot be seen here) through which the cooling medium can flow and does flow during normal use. The individual storage cells 2 make thermally conductive contact with this cooler 3 on, in each case, one of their end faces (although this cannot be seen here). This end face, which forms the base 5 of the storage cells during normal use of the battery 1, is in this case sufficient to reliably dissipate the heat created in the battery to the cooling medium, typically a 1:1 mixture of water and glycol. This cooling medium in this case flows through the cooler 3 as part of a cooling circuit, and in turn dissipates the absorbed heat to a different point in the cooling circuit, for example via a cooling heat exchanger which, for example, is coupled to the surrounding area or to an air-conditioning system.

The arrangement of the cooler 3 in contact with the base 5 of the storage cells 2 in this case allows a particularly compact design since no further elements need be provided between the individual storage cells 2. The cooler can therefore also be very small and may have a simple geometric shape. The battery 1 is therefore extraordinarily compact and can be produced at low cost. Furthermore, that end face 6 of the storage cells 2 which faces away from the base is freely accessible even when the storage cells 2 are mounted in the cooler 3. Since this end face, which is also referred to as a cover 6, is typically fitted with the electrical connecting element, this makes it possible to ensure that the electrical circuitry from the battery 1 is simple and easily accessible. Normally, the connecting elements are also fitted with the necessary electronics, cell monitoring, state of charge averaging, charge compensation, etc. Consequently, although these components are cooled via contact with the storage cell 2, and together with them, there is however, virtually no need to be concerned about any contact between the electronics and the liquid cooling medium, even in the event of possible damage to the cooler 3.

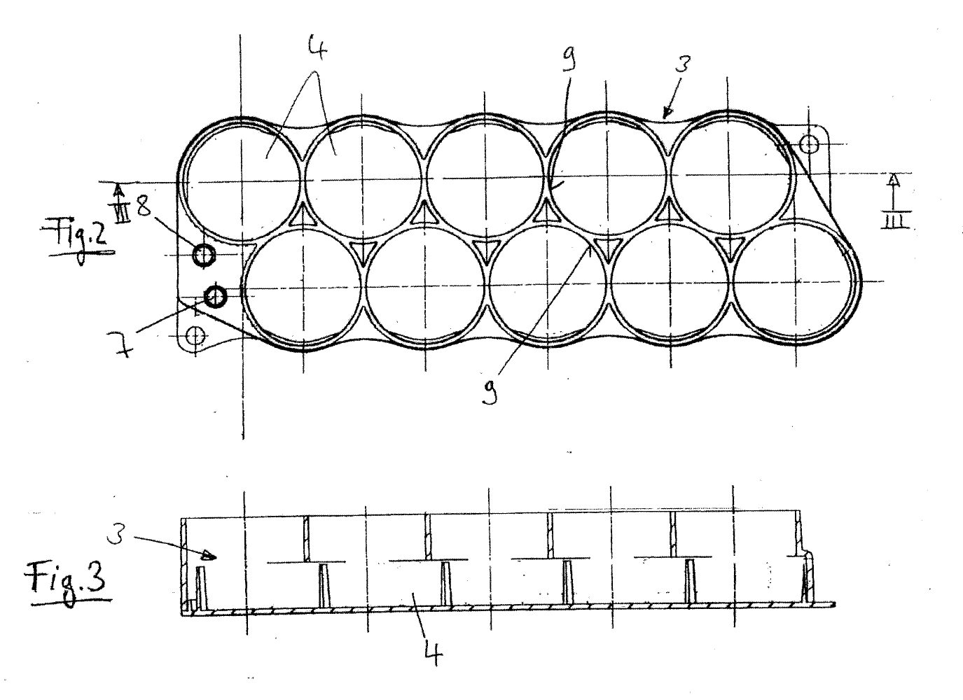

FIG. 2 and FIG. 3 show the design of the cooler 3 and of the volume 4 which is surrounded by it and through which the cooling medium can flow. In this case, the cooling medium can flow through a supply line 7 into the cooler 3, and is carried away from its area again through an output line 8. The volume flow of the cooling medium in the cooler 3 can then be guided by means of guide ribs, which are not illustrated explicitly here, such that this results in an incident flow on all the storage cells 2, and therefore in them being cooled.

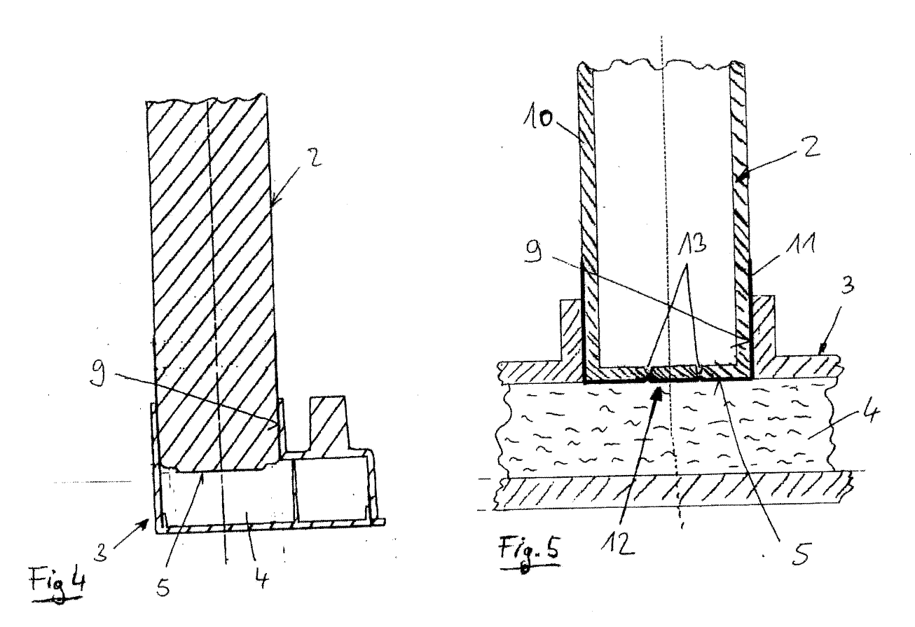

As can be seen by way of example in FIG. 4, using the example of one of the storage cells 2, the storage cells 2 are introduced into the round openings 9 and can be seen well in FIG. 2. Their bases 5 then project into the volume 4. The cooling medium therefore flows around the base 5 of the respective storage cell 2, and the storage cell 2 is thus cooled efficiently.

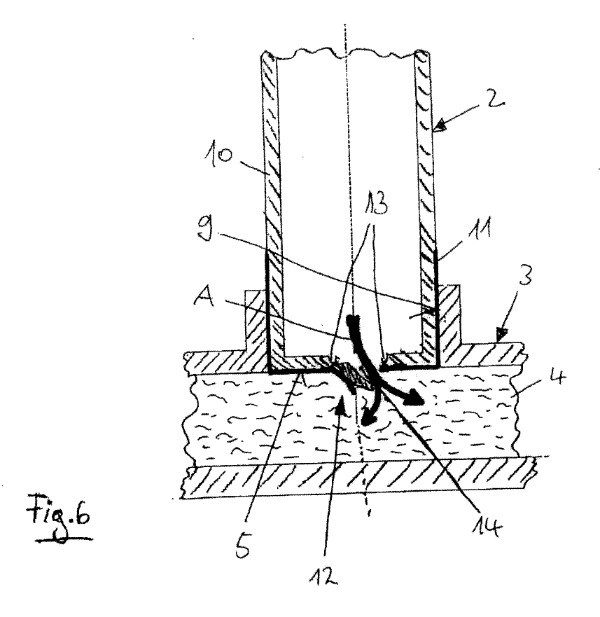

The schematic section illustration shown in FIG. 5 shows the configuration of the thermally conductive contact of the storage cells 2 with the cooling medium, once again, in detail. The storage cell 2 has a housing 10 which is typically in the form of a cup and is generally manufactured from aluminum. In this case, this housing 10 may itself be used as one of the electrical poles of the storage cell 2. During production, the storage cell 2 is closed, such that it is hermetically sealed, by a closure element in the area of the cover 6. Furthermore, this housing 10 is partially electrically isolated from the area of its base 5 by a thin layer 11. The layer 11 can in this case be chosen to be sufficiently thin that, while providing adequate electrical isolation, it nevertheless ensures adequate thermal conduction through it.

By way of example, films 11 composed of PP, PVC or PET may be used, as well as lacquers, as a material for the layer 11. Such films 11, with a layer thickness of 50 to 500 μm, can be drawn partially over the housing 10 from the side of the base 5, using a thermoforming process. They then cover the lower part (approximately ¼ to ⅓) of the housing 10, conforming to its shape. The film 11 is in this case intrinsically sealed, so that it completely seals the base 5, which comes into contact with the cooling medium, against this cooling medium. In addition, the films 11 can be adhesively bonded to the housing 10. In this case, the side walls of the housing 10 can be regarded as points for the application of the adhesive, since this means that the adhesive does not adversely affect the thermal conduction characteristics between the base 5 of the housing 10 and the cooling medium located in the volume 4.

The housing 10, provided with the layer 11, can then be inserted in the opening 9. The dimensions are designed such that this results in the storage cell 2 having a sealed interference fit, over all conceivable operating temperatures, in the opening 9. In addition, an adhesive could be used, in which case the surfaces on the layer 11 in the area of the side walls of the housing 10 can once again, in this case, be regarded as points for application of the adhesive, for the stated reasons. The cooler can therefore be sealed from the surrounding area by the storage cells 2 that have been inserted.

Each of the storage cells 2, for example, a lithium-ion store, also has a safety valve 12, in a manner known per se. The object of this safety valve 12 is now to protect the storage cell 2 against damage in the event of an explosion caused by overpressure. The safety valve 12 for this purpose opens the housing 11 of the storage cell 2 which is otherwise sealed tight, above a predetermined internal pressure.

In the exemplary embodiment of the safety valve 12 illustrated here, this safety valve 12 is provided as a passive component, in the sense described above, by means of weak points 13 in the housing 10. If an overpressure occurs in the storage cell 2, the housing 10 will break open along the weak points 13, as illustrated in FIG. 6. In this case, the thin film 11 does not represent any significant resistance to the housing 10 breaking open. In the case of a film 11, this is likewise torn open, possibly also assisted by sharp edges, created in the area of the weak points 13, on the material of the housing 10. This results, therefore, in an opening 14 in the housing 10, which, in particular allows gases to escape from the storage cell 2. The overpressure in the storage cell 2 is thus dissipated, therefore effectively preventing explosion of the defective storage cell 2, which could initiate a chain reaction with the further storage cells 2 in the battery 1.

One particularly advantageous feature in this case is that the opening 14 is created in the area of the base 5 of the storage cell 2. The gases which emerge from the defective storage cell 2, and are typically very hot and frequently cause the risk of battery fire, can thus be cooled down and rendered safe very quickly, since they are emitted directly into the cooling medium (see the arrow A in FIG. 6).

This therefore results in an extraordinarily compact, much safer and in this case low-cost battery, based on passive safety elements. A battery 1 such as this is highly suitable in particular for use in motor vehicles, which have to satisfy stringent safety requirements while occupying little physical space. The comparatively simple and low cost design is also a major advantage, owing to the large quantities involved in the field of motor vehicles.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (canceled)

15. A liquid-cooled battery for an electrical drive in a motor vehicle, comprising:
a plurality of storage cells; and
at least one volume which makes thermally conductive contact with the storage cells and through which a cooling medium can flow, with each of the storage cells having a safety valve which opens the storage cell when a predetermined media pressure in it is exceeded, and connects the volume of the storage cells to the surrounding area,
wherein the safety valves are arranged in the storage cells such that, when one of the safety valves is opened, a connection is produced between the volume and the interior of the storage cell to the open safety valve.

16. The liquid-cooled battery as claimed in claim 15, wherein the safety valves of the storage cells are each arranged on an end face of the storage cells and the end faces make thermally conductive contact with the volume.

17. The liquid-cooled battery as claimed in claim 16, wherein electrical connecting elements of the storage cells are each arranged on one of the end faces of the storage cells, with the safety valves being arranged on the opposite end face.

18. The liquid-cooled battery as claimed in claim 16, wherein at least the end face of the storage elements which has the safety valve, together with the safety valve, are coated with a liquid-tight film and project at least partially into the volume.

19. The liquid-cooled battery as claimed in claim 18, wherein the liquid-tight film is applied to the storage cells by thermoforming.

20. The liquid-cooled battery as claimed in claim 18, wherein the liquid-tight film is adhesively bonded to the storage cell.

21. The liquid-cooled battery as claimed in claim 20, wherein the areas with the adhesive bonding are located outside the areas which make thermally conductive contact with the volume.

22. The liquid-cooled battery as claimed in claim 18, wherein the liquid-tight film has a layer thickness of 50 to 500 μm.

23. The liquid-cooled battery as claimed in claim 18, wherein the liquid-tight film is composed of one of the materials, PP, PVC or PET.

24. The liquid-cooled battery as claimed in claim 16, wherein at least that end face of the storage elements which has the safety valve is, together with the safety valve, covered with a liquid-tight layer composed of a lacquer and project these partially into the volume.

25. The liquid-cooled battery as claimed in claim 15, wherein the storage cells are cylindrical and are arranged alongside one another, offset with respect to one another, in at least two rows with the cooling being provided by thermally conductive contact between an end face of the storage cells and the volume.

26. The liquid-cooled battery as claimed in claim 25, wherein the volume has guide ribs, ensuring that the incident flow strikes all the areas which are in thermally conductive contact with the storage cells.

27. The liquid-cooled battery as claimed in claim 15, wherein the volume is surrounded by a cooler with an inlet line and an outlet line for the cooling medium, the cooler has openings in which the storage cells are arranged such that the volume is sealed tight.

28. A method for operation of a liquid-cooled battery for an electrical drive in a motor vehicle, having a plurality of storage cells and at least one volume which makes thermally conductive contact with the storage cells and through which a cooling medium flows, with a safety valve being opened above a predetermined pressure limit in the event of a pressure rise, based on a fault, in any of the memory cells, comprising:
producing, when the safety valve is opened, a connection between the volume and the storage cell so that the overpressure can escape into the cooling liquid.
